(19) United States
(12) Patent Application Publication
(10) Pub. No.: US 2023/0207787 A1
(43) Pub. Date: Jun. 29, 2023

(54) Method to Improve Sodium Electrochemical Interfaces of Sodium Ion-Conducting Ceramics

(71) Applicant: National Technology & Engineering Solutions of Sandia, LLC, Albuquerque, NM (US)

(72) Inventors: Erik David Spoerke, Albuquerque, NM (US); Martha Gross, Albuquerque, NM (US); Stephen Percival, Albuquerque, NM (US); Leo J. Small, Albuquerque, NM (US)

(21) Appl. No.: 18/092,373

(22) Filed: Jan. 2, 2023

Related U.S. Application Data
(63) Continuation-in-part of application No. 17/104,306, filed on Nov. 25, 2020, now Pat. No. 11,545,723.
(60) Provisional application No. 62/940,697, filed on Nov. 26, 2019.

(51) Int. Cl. H01M 4/38; H01M 10/24; H01M 4/48; H01M 4/36; H01M 4/04

(52) U.S. Cl. CPC H01M 4/381; H01M 10/24; H01M 4/48; H01M 4/366; H01M 4/0402

(57) ABSTRACT

The present invention is directed to the modification of sodium electrochemical interfaces to improve performance of sodium ion-conducting ceramics in a variety of electrochemical applications. Enhanced mating of the separator-sodium interface by means of engineered coatings or other surface modifications results in lower interfacial resistance and higher performance at increased current densities, enabling the effective operation of molten sodium batteries and other electrochemical technologies at low and high temperatures.

### CROSS-REFERENCE TO RELATED APPLICATIONS

This application is a continuation-in-part of U.S. application Ser. No. 17/104,306, filed Nov. 25, 2020, which claims the benefit of U.S. Provisional Application No. 62/940,697, filed Nov. 26, 2019, both of which are incorporated herein by reference.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to sodium electrochemical technologies and, in particular, to coating or otherwise modifying the surfaces and interfaces of sodium ion-conducting ceramics to improve sodium electrochemical properties and performance.

### BACKGROUND OF THE INVENTION

Numerous technologies rely on the electrochemistry of metallic sodium (Na), and many of these systems, by necessity, use a sodium ion-conducting solid-state electrolyte as a separator or membrane to enable the sodium electrochemistry. Such technologies include, but are not limited to, sodium-based batteries, material purification (Na removal from NaOH-rich radioactive waste), molten sodium upgrading (MSU) of oil feedstocks, chemical synthesis or production, alkali-metal thermal-to-electric converters (AMTEC), sometimes referred to as “Sodium Heat Engines (SHE)”, and purification of sodium-contaminated materials. See J. H. Gordon, “Post Retort, Pre Hydro-treat Upgrading of Shale Oil,” Final Report, DOE Award No. DE-FE0000408 (January, 2013); U.S. Pat. No. 6,235,183 to Putter; Y. Guo, “Mixed Ionic and Electronic Conducting Electrode Studies for an Alkali Metal Thermal to Electric Converter,” Ph.D. Thesis Dissertation, Texas A&M University (December, 2006); M. S. Fountain et al., Sep. Sci. Technol. 43(9-10), 2321 (2008); and D. E. Kurath et al., Sep. Sci. Technol. 32(1-4), 557 (1997). In each of these technologies, the interface between sodium metal, which can be solid or molten, and the sodium ion-conducting ceramic is critical to efficient electrochemical function. Many of these technologies use an electrochemical interface between sodium and sodium ion-conducting ceramics, such as NaSICON (Sodium (Na) Super Ion CONductor) or beta-alumina (β″-Al₂O₃).

An exemplary technology that uses a sodium ion-conducting electrochemical interface is the molten sodium battery. Molten sodium batteries offer great promise as safe, cost-effective, reliable grid-scale energy storage system due to their high theoretical energy capacity and use of inexpensive and widely abundant materials. See S. Sorrell, Renewable Sustainable Energy Rev. 47, 74 (2015); H. Safaei and D. W. Keith, Energy Environ. Sci. 8, 3409 (2015); K. B. Hueso et al., Energy Environ. Sci. 6, 734 (2013); and L. J. Small et al., J. Power Sources 360, 569 (2017). Widespread adoption of molten sodium batteries, however, has been limited by the high operating temperatures (˜300-350° C.) necessary, in part, to achieve facile charge transfer between the molten sodium anode and the solid electrolyte separator needed for desirable battery performance. See K. B. Hueso et al., Energy Environ. Sci. 6, 734 (2013); and K. B. Hueso et al., Nano Res. 10, 4082 (2017). The enabling of low temperature operation of molten sodium batteries would unlock the promise of these systems, as lowering the operating temperature increases battery longevity, reduces materials cost, and increases safety, making these systems substantially more attractive for widespread adoption. See L. J. Small et al., J. Power Sources 360, 569 (2017); and H.-J. Chang et al., Adv. Mater. Interfaces 5, 1701592 (2018).

Traditional high temperature molten sodium batteries, such as Na—S or Na—NiCl₂, rely on the use of β″-Al₂O₃ solid electrolyte as a separator. See K. B. Hueso et al., Energy Environ. Sci. 6, 734 (2013); and K. B. Hueso et al., Nano Res. 10, 4082 (2017). Sodium beta batteries, as they are often called, suffer dramatically from the poor wetting of molten sodium on β″-Al₂O₃, a problem that is greatly exacerbated as the temperature drops below 250° C. See K. B. Hueso et al., Nano Res. 10, 4082 (2017); K. Ahlbrecht et al., Ionics 23, 1319 (2017); M. Holzapfel et al., Electrochim. Acta 237, 12 (2017); X. Lu et al., Nat. Commun. 5, 4578 (2014); and D. Reed et al., J. Power Sources 227, 94 (2013). Wetting of molten sodium, as determined by the measurement of contact angle, is often discussed interchangeably with charge transfer. See K. Ahlbrecht et al., Ionics 23, 1319 (2017). Contact angle is often a reflection of the degree of physical contact between the molten sodium and the ceramic separator at their interface. A low contact angle of <90° implies intimate contact between the Na and the ceramic surface, while a high contact angle (>90°) implies poor contact at the Na-ceramic interface. Poor interfacial contact between the Na and the ceramic limits the surface area through with Na⁺ ions can travel, which dramatically increases the interfacial resistance as cations such as Na⁺ can only travel through localized “choke points” through the ceramic. See W. Zhou et al., ACS Cent. Sci. 3, 52 (2017); K. Fu et al., Sci. Adv. 3, e1601659 (2017); M. J. Wang et al., Joule 3, 2165 (2019); and S. Wei et al., Acc. Chem. Res. 51, 80 (2018).

One method to improve wetting on β″-Al₂O₃ has been the extensive application of coatings, such as Ni nanowires, porous carbons, porous iron oxide, Pb particles, Bi islands, and a screen-printed Pt grid. See X. Lu et al., Nat. Commun. 5, 4578 (2014); Y. Hu et al., J. Power Sources 240, 786 (2013); Y. Hu et al., J. Power Sources 219, 1 (2012); Y. Hu et al., Solid State Ionics 262, 133 (2014); H.-J. Chang et al., J. Mater. Chem. A 6, 19703 (2018); and D. Jin et al., ACS Appl. Mater. Interfaces 11, 2917 (2019). A second method that has been tested on β″-Al₂O₃, is alloying the Na anode with low melting temperature alkali metals or with other relatively low melting temperature metals, such as Bi or Sn, to improve wetting. See K. Ahlbrecht et al., Ionics 23, 1319 (2017); X. Lu et al., Nat. Commun. 5, 4578 (2014); D. Reed et al., J. Power Sources 227, 94 (2013); Y. Hu et al., J. Power Sources 240, 786 (2013); Y. Hu et al., J. Power Sources 219, 1 (2012); D. Jin et al., ACS Appl. Mater. Interfaces 11, 2917 (2019); H. Liu et al., ACS Mater. Lett. 1, 217 (2019); and C. Wang et al., Adv. Energy Mater. 8, 1701963 (2018). However, there has been limited work undertaken to determine Na wetting below 150° C. Results from literature demonstrate that the wetting of Na, as determined by the contact angle of Na on the ceramic, proves to be very poor at temperatures below 150° C. The exception appears to be alloying Na with other low-melting temperature alkali metals (K, Rb, Cs). See X. Lu et al., Nat. Commun. 5, 4578 (2014). Safety and stability are a concern with these alloys, however. K and Rb are capable of ion exchange with the Na⁺ in β″-Al₂O₃, and the resulting volume expansion can cause the ceramic to fracture. Concerns about the safety of using the large mass of Cs necessary for grid-scale storage are noteworthy, in addition to its expense, due to its violent reactivity with water and formation of an explosive superoxide. For the time being, alloying Na with alkali metals to improve the wetting at low temperatures appears to be impractical for large scale applications.

As described above, prior work on molten Na wetting has focused on the use of β″-Al₂O₃. In the case of low temperature (T<200° C.) molten sodium batteries, however, NaSICON displays higher ionic conductivities compared to β″-Al₂O₃ at low temperature. See L. J. Small et al., J. Power Sources 360, 569 (2017); D. Reed et al., J. Power Sources 227, 94 (2013); and S. Song et al., Sci. Rep. 6, 32330 (2016). To date there have been few studies on the improvement of the interface between molten sodium and NaSICON at low temperature. One study used a deposited layer of indium tin oxide and another deposited graphene like carbon. See L. Xue et al., Adv. Energy Mater. 5, 1500271 (2015); and E. Matios et al., ACS Appl. Mater. Interfaces 11, 5064 (2019). In β″-Al₂O₃, the poor wetting of Na is often attributed to the high surface tension of molten Na, combined with the formation of Na₂O when molten Na reacts with adsorbed water on the surface of β″-Al₂O₃ or by the presence of surface Ca impurities leftover from synthesis. See X. Lu et al., Nat. Commun. 5, 4578 (2014); D. Reed et al., J. Power Sources 227, 94 (2013); D. Jin et al., ACS Appl. Mater. Interfaces 11, 2917 (2019); L. Viswanathan and A. V. Virkar, J. Mater. Sci. 17, 753 (1982); and M. W. Breiter et al., Solid State Ionics 14, 225 (1984). It is not obvious, however, if these mechanisms for poor wetting and methods to improve molten Na wetting are applicable to NaSICON, which is synthesized in a very different manner and demonstrates substantially lower water reactivity than β″-Al₂O₃.

### SUMMARY OF THE INVENTION

The present invention is directed to a method to improve a sodium electrochemical interface, comprising providing a sodium ion-conducting ceramic; depositing a coating comprising tin, bismuth, lead, antimony, germanium, silicon, or gold on a surface of the sodium ion-conducting ceramic; and forming a sodium ion-conducting sodium-tin, sodium-bismuth, sodium-lead, sodium-antimony, sodium-germanium, sodium-silicon, or sodium-gold intermetallic phase on the surface of the sodium ion-conducting type ceramic by sodium electrochemical reaction, thereby providing a sodium electrochemical interface with improved sodium ion conduction from a sodium source through the sodium ion-conducting ceramic. For example, the sodium ion-conducting ceramic can comprise NaSICON or β″-alumina. The step of depositing a coating can comprise coating the surface of the sodium ion-conducting ceramic with metallic tin, bismuth, lead, antimony, germanium, silicon, gold or alloy thereof. Alternatively, the step of depositing a coating can comprise coating the surface of the sodium ion-conducting ceramic with non-metallic compound comprising tin, bismuth, lead, antimony, germanium, silicon, or gold and chemically reducing the non-metallic compound to a metal. Alternatively, the ceramic itself may be modified to include metallic or non-metallic compounds comprising tin, bismuth, lead, antimony, germanium, silicon, or gold which can be chemically reduced to a metal.

### BRIEF DESCRIPTION OF THE DRAWINGS

The detailed description will refer to the following drawings, wherein like elements are referred to by like numbers.

FIG. 1 is a schematic illustration of a low temperature molten sodium (Na—NaI) battery.

FIG. 2 is a schematic illustration of a symmetric cell for electrochemical testing of NaSICON separators.

FIG. 3A shows SEM images of a 40 nm thick Sn coating on NaSICON at different magnifications. FIG. 3B shows SEM images of a 170 nm thick Sn coating. FIG. 3C shows SEM images of a 500 nm thick Sn coating. FIG. 3D shows SEM images of a 700 nm thick Sn coating.

FIG. 4A shows a contact angle measurement of molten Na on bare NASICON. FIG. 4B is an image of the Na drop on bare NaSICON after the measurement. FIG. 4C shows a contact angle measurement of molten Na on NaSICON with Sn coating below critical thickness. FIG. 4D is an image of the Na drop on NaSICON with Sn coating below critical thickness after the measurement. FIG. 4E shows a contact angle measurement of molten Na on NaSICON with Sn coating above critical thickness. FIG. 4F is an image of the Na drop on NaSICON with Sn coating above critical thickness after the measurement.

FIG. 5A is a graph showing measured voltages of an electrochemically cycled symmetric sodium cell assembled with bare and Sn-coated NaSICON at 110° C. FIG. 5B is a graph of average discharge voltage at different current densities. FIG. 5C is a graph of resistances obtained by DC measurement.

FIG. 6A is a graph of impedance of a symmetric cell assembled with bare NaSICON before cycling. FIG. 6B is a graph of impedance of a symmetric cell assembled with Sn-coated NaSICON before cycling. FIG. 6C is a graph of impedance of a symmetric cell assembled with bare NaSICON after cycling. FIG. 6D is a graph of impedance of a symmetric cell assembled with Sn-coated NaSICON after cycling.

FIG. 7 shows XRD of NaSICON with 700 nm Sn coating after static wetting testing and after dynamic cycling in a symmetric cell compared to database powder diffraction pattern entries. See S. Gates-Rector and T. Blanton, Powder Diffr. 34, 352 (2019). Blue stars highlight identifying Sn peaks and orange diamonds highlight identifying NaSn peaks.

FIG. 8 is a schematic illustration of a Na⁺ ion transport from a Na metal anode through bare NaSICON and enhanced Na⁺ ion transport facilitated by a low resistance NaSn chaperone phase between the NaSICON and the Na metal.

FIG. 9 shows measured voltages of an electrochemically cycled symmetric sodium cell assembled with 700-nm-thick Sn-coated NaSICON and a symmetric sodium cell assembled with 170-nm-thick Sn-coated NaSICON and pre-saturating the Na anode with Sn.

FIG. 10 is a graph showing voltage cycling with full cell comprising a Sn-coated NaSICON separator.

FIG. 11 is a photograph of a molten sodium droplet reacting with coating of SnOₓ on a NaSICON ceramic pellet at 110° C. The dark material extending out from the molten sodium droplet is the metallic Sn, reduced by the sodium. As yet unreacted SnOₓ is still visible under the dark Sn layer.

FIGS. 12A and 12B are plots showing the measured overpotentials of symmetric electrochemical cells (molten sodium on both sides of a NaSICON separator) at 110° C. for various current densities. FIG. 12A shows the high overpotentials of bare, uncoated NaSICON and the beneficial impact of a metallic Sn coating. FIG. 12B shows similar benefit of the SnOₓ coating, which undergoes a chemical transformation to Sn prior to electrochemical cycling at 110° C. Plots are shown on identical scales and the dashed line indicates the overpotential of the bare NaSICON for comparison with variously coated samples.

FIG. 13 is a plot showing the measured overpotentials of a symmetric electrochemical cell (molten sodium on both sides of a NaSICON separator) at 110° C. for various current densities. The plot highlights the fact that the SbOₓ performs similarly with Sn and SnOₓ coatings.

FIG. 14 is a plot showing the measured overpotentials of a symmetric electrochemical cell (molten sodium on both sides of a β″-alumina separator) at 110° C. for various current densities. The overpotentials for the coated sample are dramatically lower than for the uncoated ceramic.

### DETAILED DESCRIPTION OF THE INVENTION

The present invention is directed to coating or otherwise modifying the surfaces and interfaces of sodium ion-conducting ceramics, such as NaSICON and beta-alumina, to improve sodium electrochemical properties and performance. NaSICON-type ceramics represent a broad family of materials that can be generally described with basic formula A_{1+x+y}M′ₓM₂₋ₓB_{y}B′_{3-y}O₁₂ (0≤x≤2, and 0≤y≤3), which forms a three-dimensional hexagonal framework of corner-sharing oxide tetrahedra and octahedra. See Q. Ma and F. Tietz, ChemElectroChem 7, 2693 (2020); and B. E. Scheetz et al., Waste Manage. 14(6), 489 (1994). In many cases, the A represents a sodium (Na) ion or other substituting alkali ion occupying interstitial sites, while M and M′ comprise multivalent transition metal cations (M is commonly tetravalent, while M′ can be trivalent, tetravalent, or pentavalent) that occupy octahedral sites. B and B′ form the tetrahedra and B is typically silicon and B′ is typically phosphorus. The NaSICON structure can accommodate significant substitutions on A, M, and B sites, including a large fraction of the periodic table, making it a widely versatile and tailorable material. To date, the most highly conductive compositions of NaSICON-type ceramics typically involve silica and phosphate tetrahedra, zirconia octahedra, and sodium at the A site. Although the examples below describe traditional NaSICON compositions (e.g., Na_{1+y}Zr₂Si_{y}P_{3-y}O₁₂, 0≤y≤3), the invention is generally applicable to all NaSICON-type ceramics. Beta-alumina is a sodium polyaluminate ceramic that can be complexed with a mobile ion, including Na⁺. β″-Al₂O₃ is a good conductor of its mobile ion yet allows no non-ionic (i.e., electronic) conductivity. The crystal structure of the β-alumina provides an essential rigid framework with channels along which the ionic species of the solid can migrate.

In particular, the present invention is directed to sodium intermetallic-forming interfaces to provide improved mating of sodium ion-conducting surfaces with reduced interfacial resistance and more efficient charge transfer properties or sodium (or sodium alloy) adhesion to the sodium ion-conducting ceramic. The intermetallic interface can be formed by first coating the surface with a material that forms a sodium ion-conducting intermetallic phase with sodium. The starting coating material needs to be insoluble or sparingly soluble (<<1 wt %) in sodium at the temperature at which the intermetallic is formed. In general, the coating can comprise a metal or metalloid, or an alloy, oxide, sulfide, or chalcogenide thereof, that is capable of reacting with sodium to form the intermetallic interface. For example, the metal can comprise a group 14 or 15 post-transition metal, such as tin, bismuth, or lead, which are known to form sodium ion-conducting intermetallic compounds. For example, the metalloid can be silicon, germanium, or antimony. For example, exemplary oxides include Sb₂O₃, GeO₂, and SnO₂. The coating can be deposited by sol-gel chemistry evaporation, pulsed-laser deposition, chemical vapor deposition, atomic layer deposition, sputtering, or other methods common to the field. Alternatively, the ceramic interface can be formed through direct modification or doping the ceramic material structure. For example, a metal-substituted NaSICON (e.g., Sn substitution), either in bulk or at the NaSICON surface, can be used as a sacrificial reactive layer to improve the sodium interface. For example, NaSICON with a nominal composition Na₃Zr₂₋ₓSnₓPSi₂O₁₂ (0≤x≤2) is an example of where tin incorporation into at least part of a NaSICON ceramic (not necessarily through the entirety of the ceramic body) can provide a source of reactive tin precursor. See P. Yadav and M. C. Bhatnagar, J. Electroceram. 30, 145 (2013). In any case, the resulting intermetallic must be a sodium ion conductor. Further, the resulting intermetallic needs to have a melting temperature higher than the operating temperature at which the sodium ion-conducting ceramic is used. Therefore, to form the intermetallic interface, the coating or interfacial layer can be applied to the ceramic surface at a temperature below the melting temperature of the coating material, forming an intermetallic interface that melts or degrades at a higher temperature. For example, as will be described below, a NaSn “chaperone” phase can be formed at a low temperature to avoid melting of the Sn coating. However, the resulting intermetallic NaSn phase is stable to much higher temperatures and can facilitate improved performance of the sodium electrochemical interface at temperatures well above 200° C. Therefore, the intermetallic interface can be operated either at the low temperature at which it forms or at a higher temperature, but below the temperature at which the intermetallic phase melts of otherwise degrades. The coatings can improve the physical, chemical, and electrochemical interfaces between sodium and a ceramic electrolyte at reduced temperatures (e.g., below 200° C.), or in higher temperature operations. Therefore, in addition to enabling low temperature molten sodium batteries, there are several other applications for which the invention may be beneficial.

### Example: Low Temperature Molten Sodium Battery

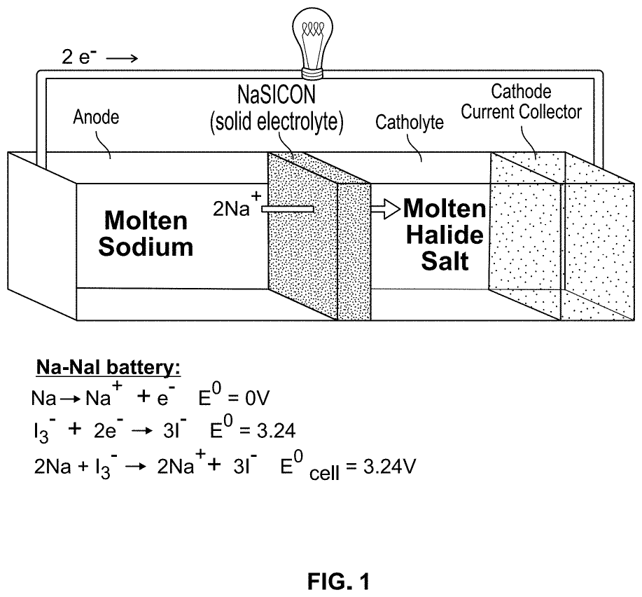

Although the invention can be applied to any technology that uses a sodium electrochemical interface with a sodium ion-conducting ceramic, an exemplary application of the invention is a sodium-NaSICON interface in a low temperature molten sodium battery. A schematic illustration of a low temperature molten sodium battery is shown in FIG. 1. This exemplary molten sodium battery comprises a sodium-based liquid metal anode, a NaSICON ion-conducting separator, an inorganic molten halide salt catholyte, and anode and cathode current collectors. The sodium-based liquid metal anode can comprise pure molten sodium (as shown) or an alloy of sodium and other alkali metal(s), such as lithium, potassium, rubidium, or cesium. Liquid sodium metal is a preferable anode material, due to its high energy density, electrochemical reversibility, high electrical conductivity (10⁵ S/cm), low melting point (98° C.), earth abundance, and relative safety. See S. Ha et al., ChemPhysChem 15, 1971 (2014); K. Hueso et al., Energy Environ. Sci. 6, 734 (2013); W.-L. Pang et al., J. Power Sources 356, 80 (2017); and F. Wan et al., Nano Energy 13, 450 (2015). The separator electrically isolates the two electrolytes (anode and cathode) and allows conduction of cations to maintain charge balance across the two electrolytes. Preferably, a zero-crossover separator selectively favors transport of the desired charge carrier, Na⁺, and prevents transport of redox-active molecules and solvents that can contribute to capacity loss. In particular, it has been found that some NaSICON ceramics retain significant conductivity at low temperatures <200° C. and provide a mechanically robust ceramic separator that is chemically and electrochemically compatible with liquid sodium and halide salts. See A. Jolley et al., Ionics 21, 3031 (2015); A. Jolley et al., J. Amer. Ceram. Soc. 98, 2902 (2015); X. Lu et al., J. Power Sources 195, 2431 (2010); X. Lu et al., J. Power Sources 215, 288 (2012); and J. Kim et al., J. Electroanal. Chem. 759, 201 (2015). For example, Na₃Zr₂Si₂PO₁₂ has a Na-ion conductivity of >10⁻⁴ S/cm and variants can exceed 10⁻³ S/cm at 25° C. In addition to molten halide salts, the catholyte can comprise a variety of materials, including organic solvents, aqueous electrolytes, ionic liquids, sulfur/polysulfides, or molten salts. The cathode current collector preferably has a high surface area and is chemically and electrochemically inert, enabling fast charge transfer. For example, the cathode current collector can comprise tungsten rods or an activated carbon felt. The current collector oxidizes or reduces the catholyte during charging and discharging (i.e., extracts electrons from the catholyte during charging and injects electrons into the catholyte during discharging).

An exemplary liquid catholyte comprises NaI complexed in AlBr₃, which has a low melting temperature (e.g., <100° C.). See U.S. Pat. No. 11,258,096, issued Feb. 22, 2022, which is incorporated herein by reference. This catholyte can make use of the reversible iodide/triiodide redox couple to store and release charge and which has been shown to have a high energy density. See Y. Zhao et al., Nat. Commun. 4, 1896 (2013). The redox chemistry for the Na—NaI battery in shown in FIG. 1. Importantly, however, when the operating temperature of the battery is reduced to near 100° C., sodium wetting of the NaSICON ceramic separator becomes very poor, resulting in high interfacial resistance and poor battery performance, particularly at current densities relevant to large format battery function. In particular, improper wetting leads to current constriction through small active areas of the separator, eventually forming shorts.

As an example of the invention, Sn coatings of various thicknesses on NaSICON were investigated for the purposes of enhancing interfacial contact and charge transfer between molten sodium and the solid electrolyte at low temperature. A dramatic lowering of overpotential in molten sodium symmetric cells with a NaSICON separator by the application of these Sn coatings was demonstrated. It was found that in-situ formation of a tin-based NaSn chaperone phase on the NaSICON ion conductor surface greatly improved charge transfer and lowered interfacial resistance in sodium symmetric cells operated at 110° C. and current densities up to 50 mA cm⁻². It was further shown that static wetting testing, as measured by the contact angle of molten sodium on NaSICON, does not accurately predict battery performance due to the dynamic formation of the Na⁺ ion conducting NaSn chaperone phase during cycling.

### Wettability of Bare and Tin-Coated NaSICON

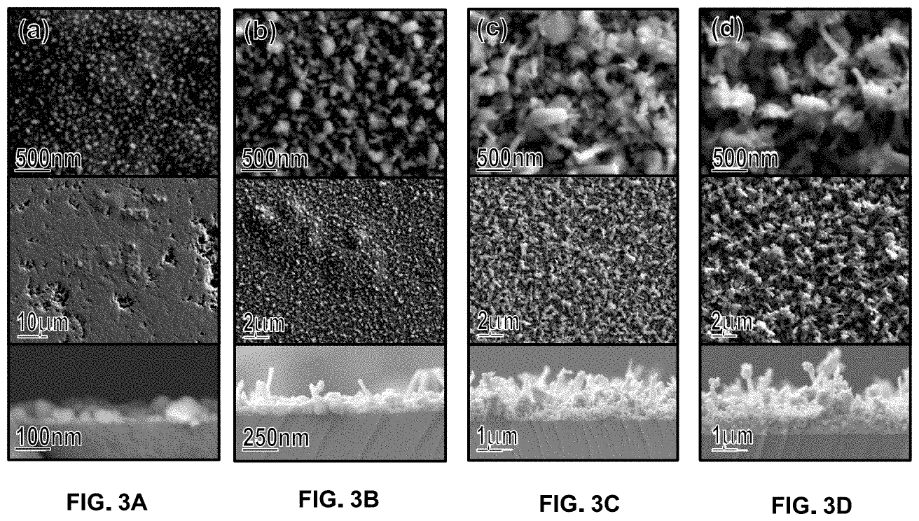

In order to better understand the phase evolution of the Na—Sn—NaSICON interphase and its influence on interfacial resistance and practical battery performance, a series of NaSICON samples were prepared with Sn coatings systematically varied in thickness from 0 to 700 nm. The Sn coatings were deposited by radio frequency (RF) magnetron sputtering and pure Sn phase was confirmed by x-ray diffraction (XRD) and energy-dispersive x-ray spectroscopy (EDX). Coating thickness was measured by profilometry and scanning electron microscopy (SEM) of the cross-section of Sn coatings on glass slides. The thicknesses of the dense portion of the coating (neglecting rough surface features) were nominally 40 nm, 170 nm, 500 nm, and 700 nm. FIGS. 3A-D show representative images of the Sn coatings at each thickness. Each of the Sn coatings, as deposited, exhibit substantial roughness in their surface morphology, with surface roughness increasing with increasing coating thickness. SEM of the coating cross-section shows that the 40 nm coatings were non-conformal, with some bare patches of substrate on the order of a few nanometers. All other coatings cover the substrate surface completely, as verified by EDX maps confirming the Sn coating on a NaSICON substrate.

As discussed above, there have been limited studies to date on the wetting of molten sodium on NaSICON solid electrolytes, and no studies have been performed previously at low temperatures (<150° C.). Previous work to improve molten Na wetting on β″-Al₂O₃ has described the importance of the “critical thickness” of a coating, in relation to coatings made of metals that are partially soluble in molten sodium. See D. Reed et al., J. Power Sources 227, 94 (2013); and D. Jin et al., ACS Appl. Mater. Interfaces 11, 2917 (2019). Critical thickness is the thickness above which the metal coating exceeds its solubility limit in the molten sodium, at which point a layer of the metal coating remains after contact with the molten sodium. Previous work has either used metal coatings below the critical thickness or developed island- or grid-type coating structures so as to prevent depositing a metal blocking layer on the ceramic surface. See K. Ahlbrecht et al., Ionics 23, 1319 (2017); X. Lu et al., Nat. Commun. 5, 4578 (2014); D. Reed et al., J. Power Sources 227, 94 (2013); H.-J. Chang et al., J. Mater. Chem. A 6, 19703 (2018); and D. Jin et al., ACS Appl. Mater. Interfaces 11, 2917 (2019).

Sn is sparing soluble in Na. The solubility limit of Sn at 110° C. was calculated to be 6.7×10⁻³ wt % Sn using the FactSage 7.4 FTlite database. See E. Matios et al., ACS Appl. Mater. Interfaces 11, 5064 (2019); and FactSage 7.4 FTlite Database, http://www.crct.polymtl.ca/fact/documentation/, (accessed October 2019). For contact angle measurements taken by sessile drop technique, the critical thickness was estimated to be 100 nm. For symmetric cells, discussed later, the critical thickness was estimated to be 220 nm, due to the larger mass of sodium (4 g) and increased contact area (1.76 cm²). Accordingly, the coating thicknesses of 40 nm to 700 nm were both above and below the critical thickness, as determined by the solubility of Sn.

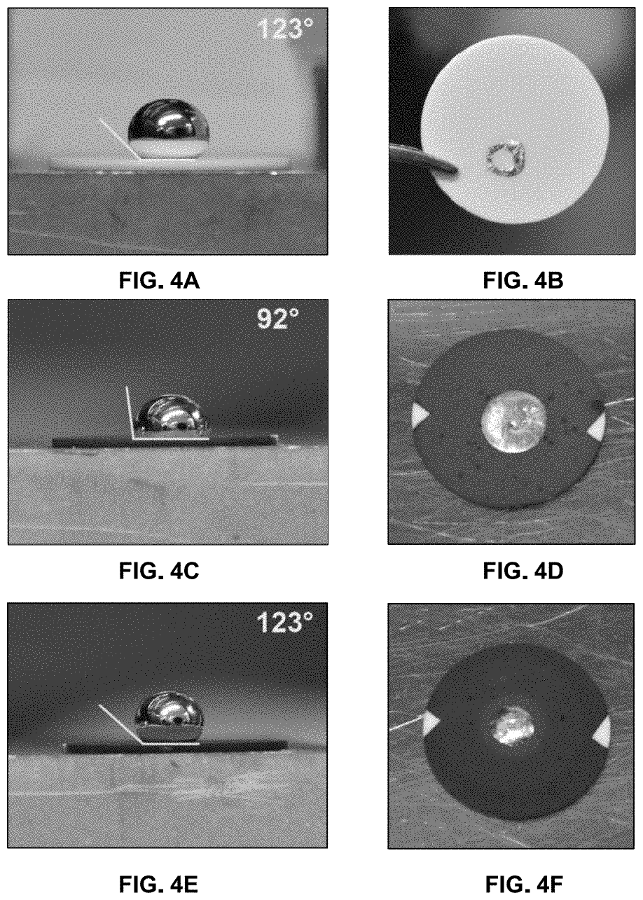

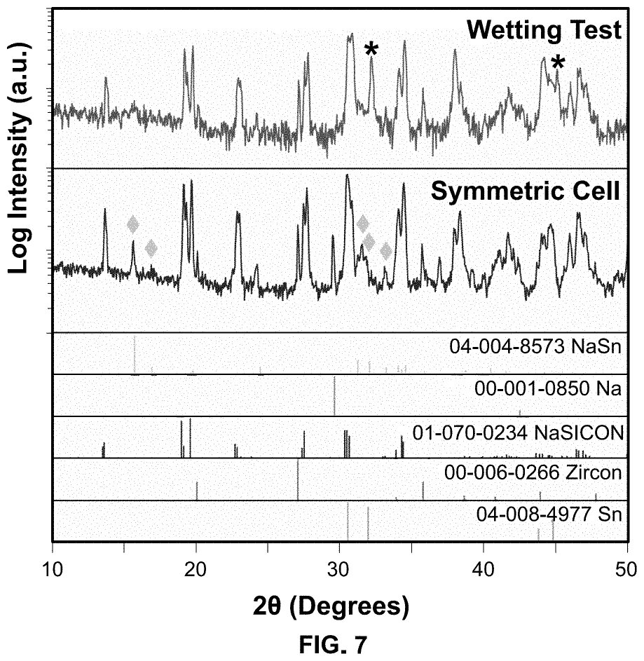

Wettability testing was performed, as contact angle measurement is typically used as a method of screening different materials and approaches to improve wetting of molten sodium to a solid electrolyte. Wettability of the molten Na on the NaSICON was determined by the sessile drop technique, in which the contact angle of a molten Na drop was measured on bare NaSICON and on Sn-coated NaSICON, in which the Sn coating thicknesses were below and above the critical thickness. A contact angle of <90° is considered to demonstrate wetting of the liquid to the solid surface, while a contact angle of >90° is considered to be nonwetting. As shown in FIG. 4A, molten sodium wet poorly to bare NaSICON at 110° C. and achieved a best contact angle of 123°. As shown in FIG. 4C, molten Na achieved a best contact angle of 92° to NaSICON coated with Sn below the critical thickness. As shown in FIG. 4E, when coated with Sn above the critical thickness, molten Na achieved a contact angle similar to that on bare NaSICON. This angle is also like that achieved with a molten Na—Sn alloy on bare NaSICON. Interestingly, Sn coatings exhibited a slight color change after deposition of the Na drop, seen most clearly in FIG. 4F as a ring of blue around the Na. Literature indicates a possible sodiation of the Sn, but XRD was unable to reveal any new phase formation, as is further illustrated in FIG. 7. See J. S. Gutierrez-Kolar et al., ACS Appl. Energy Mater. 2, 3578 (2018). Removal of the Na drop further demonstrates the poor wetting of the Na on bare NaSICON, shown in FIG. 4B, as most of the Na was easily removed. Na was difficult to remove from both Sn-coated NaSICON coupons, regardless of Sn thickness, as shown in FIGS. 4D and 4F, indicating better adherence of Na to the NaSICON surface with a Sn coating. In sum, Sn coatings below the critical thickness enhanced Na wetting on NaSICON, while Sn coatings above the critical thickness did not change the contact angle as compared to bare NaSICON.

### Performance of NaSICON Electrochemical Cells

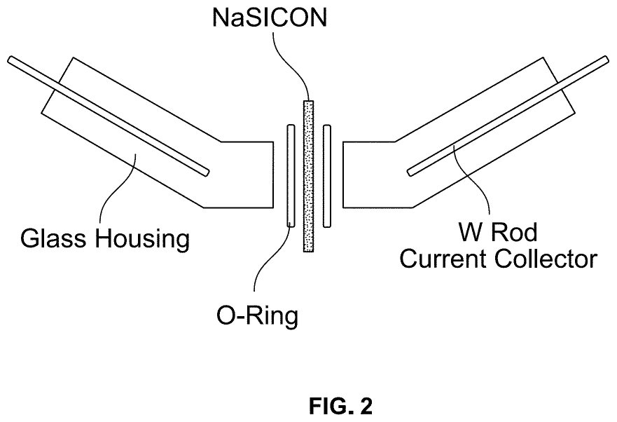

It is typically reasoned that improvement in the contact angle should correlate to decreased interfacial resistance and overall battery performance. The primary goal of this invention, however, is not explicitly improved contact angle but instead improved charge transfer and lower interfacial resistance in a molten sodium battery. With this in mind, symmetric cells, as shown in FIG. 2, were assembled using bare NaSICON and Sn-coated NaSICON to verify that the improved wettability observed in the contact angle testing correlated to lowered interfacial resistance and improved battery performance. A piece of NaSICON, with or without Sn coating, was placed between two Na-filled chambers and the cell was sealed with EPDM O-rings in an argon atmosphere. The geometric area of the planar NaSICON was 1.76 cm². Symmetric cells were tested with Sn coatings at thicknesses above (500 nm, 700 nm) and below (40 nm, 170 nm) the estimated critical thickness of 220 nm at 110° C.

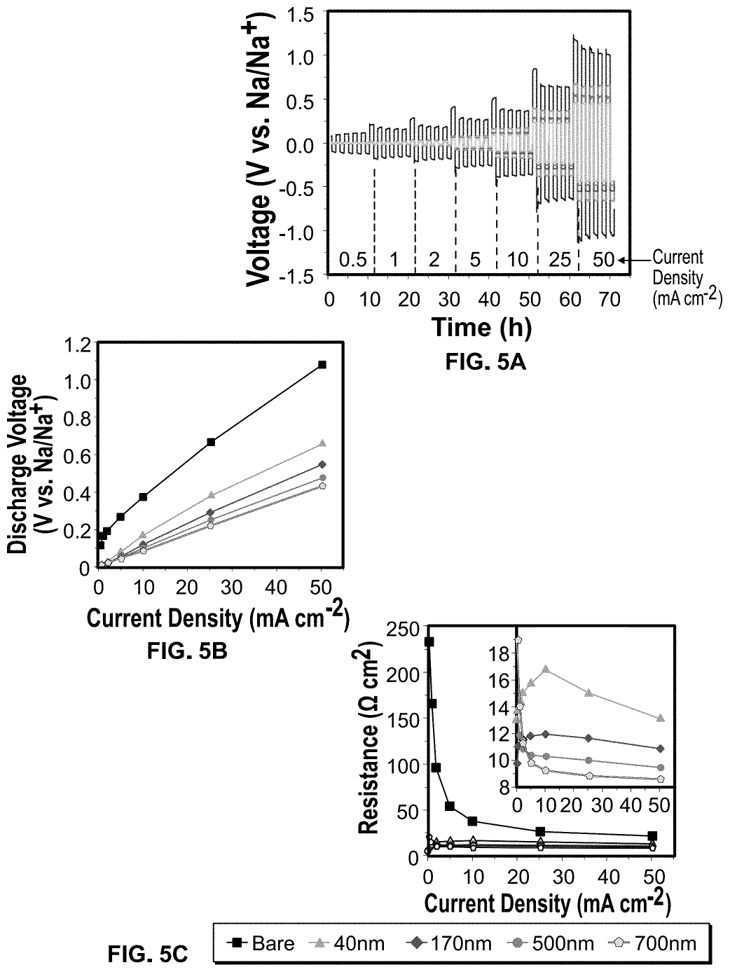

The symmetric cells were cycled at different current densities to determine the effect of Sn-coated NaSICON on battery performance. Cells were cycled for 5 cycles at each current density, starting at 0.5 mA cm⁻² and increasing up to 50 mA cm⁻². As can be seen in FIGS. 5A, the application of a Sn coating on NaSICON substantially lowers the overpotential of a symmetric cell compared to a cell assembled with bare NaSICON. Moreover, the presence of Sn stabilizes the cycling behaviour. Whereas bare NaSICON displayed a charging voltage higher on the first cycle than subsequent cycles, Sn-coated NaSICON displayed a consistent charge-discharge profile. Analysis of the NaSICON after cycling shows that Sn-coated NaSICON demonstrates excellent wetting to the Na compared to bare NaSICON, regardless of Sn coating thickness. Contrary to what was expected from the static contact angle testing, overpotential decreases with increasing Sn coating thickness; cells with coatings above the critical thickness (500 nm, 700 nm) show better performance compared to cells with coatings below the critical thickness (40 nm, 170 nm), as shown in FIG. 5B. From the contact angle testing alone, it would have been expected that very thick layers of Sn would have demonstrated large overpotentials due to poor wetting of the Na. Furthermore, a thick layer of Sn present at the interface would have been expected to act as a blocking layer, preventing the transport of Na⁺ ions as has been demonstrated previously with conformal Bi coatings. See D. Jin et al., ACS Appl. Mater. Interfaces 11, 2917 (2019). Instead, these results show that cells with thick Sn coatings above the critical thickness perform better than those with Sn coatings below the critical thickness, as shown in FIG. 5C.

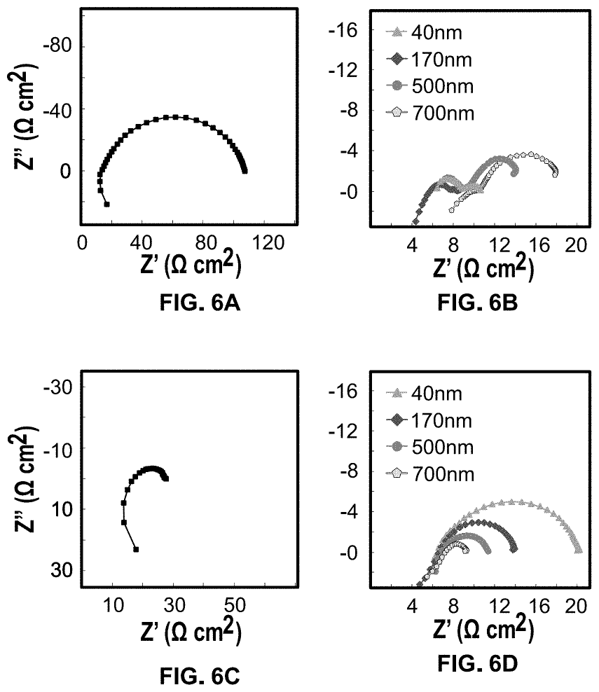

As one measure of charge transfer, impedance spectroscopy was performed on all symmetric cells before and after cycling. Characteristic Nyquist plots are shown in FIGS. 6A-D. Generally, impedance spectra were offset along the Z′ axis and display one or two semicircles in the complex impedance plane. This offset, related to the series resistance of the cell, is dominated by the NaSICON separator, but also includes the tungsten current collector, Na metal, and any bulk Sn-like coating on the NaSICON. The widths of the semicircles are attributed to charge transfer resistances across the Na—NaSICON interface. Thus, small semicircles with a small offset (i.e., closer to 0,0) are indicative of low resistances and superior cell performance. Before cycling, a marked difference is seen between cells with or without a Sn coating. As shown in FIG. 6A, for cells assembled with bare NaSICON (no Sn coating), one large semicircle 53Ω in diameter is seen, displaced 7.9Ω along the Z′ axis. The large semicircle diameter is attributed to a large interfacial charge transfer resistance between the Na and the NaSICON. The Z′ axis offset is over double the resistance expected for NaSICON, implying poor surface contact between the molten Na and the NaSICON, as would be expected based on the contact angle measurements.

As shown in FIG. 6B, the addition of a Sn coating to the NaSICON separator in an uncycled cell not only decreases the semicircle diameter by an order of magnitude, but also lowers the Z′-axis offset by more than a factor of two. That is to say, the Sn coating decreases both the interfacial charge transfer resistance as well as the series resistance of the cell. This series resistance of ˜3.4Ω is on par with that expected for NaSICON bulk and grain boundary resistances, implying improved surface contact with the NaSICON. While this performance is expected for Sn coatings below the critical thickness from contact angle testing, a similar trend for Sn coatings above the critical thickness is seen as well. This trend implies that despite poor contact angles, molten sodium still achieves a good surface contact on the Sn-coated NaSICON. It is important to note that upon adding a Sn coating, another semicircle appears in the Nyquist plot. This additional semicircle is attributed to the replacement of the Na—NaSICON interface with the Na—Sn and Sn—NaSICON interfaces. Overall, these two interfacial resistances sum to much less than that of the Na—NaSICON interfacial resistance seen in the case of bare NaSICON (˜3 versus ˜53Ω). Thus, the Sn coating decreases the resistance of the system by both improving contact area by over a factor of two and decreasing the charge transfer resistance of the Na—NaSICON interface by greater than a factor of ten.

As shown in FIG. 6C, after cycling the cells assembled with bare NaSICON demonstrate a larger series resistance, shown by a shift in the impedance spectra to a more positive position along the Z′ axis. This indicates no improvement to the contact area between the Na and the NaSICON during battery cycling. A decrease in the semicircle diameter occurred, indicating improved charge transfer. As shown in FIG. 6D, cells assembled with Sn-coated NaSICON see the two semicircles present before cycling (FIG. 6B) change to a single semicircle after cycling, regardless of Sn coating thickness. This change suggests an evolution of the structure at the Na—NaSICON interface. As the Sn thickness increases from 40 nm to 700 nm, a clear trend is observed: the width of the semicircle decreases, while simultaneously shifting more positive along the Z′ axis. This is interpreted to mean that the charge transfer resistance across the Na—NaSICON interface decreases, while the series resistance of the cell modestly increases. Thus, increasing the starting Sn thickness effectively decreases the interfacial resistance of the Na—NaSICON interface after cycling. At the same time, increasing the Sn thickness modestly increases the series resistance of the cell by adding another highly conductive phase that the ions must pass through during cycling. This can be envisioned as a low resistance ionic chaperone phase, which facilitates the Na⁺ ion transfer between the NaSICON and the Na metal.

### Intermetallic NaSn “Chaperone” Phase

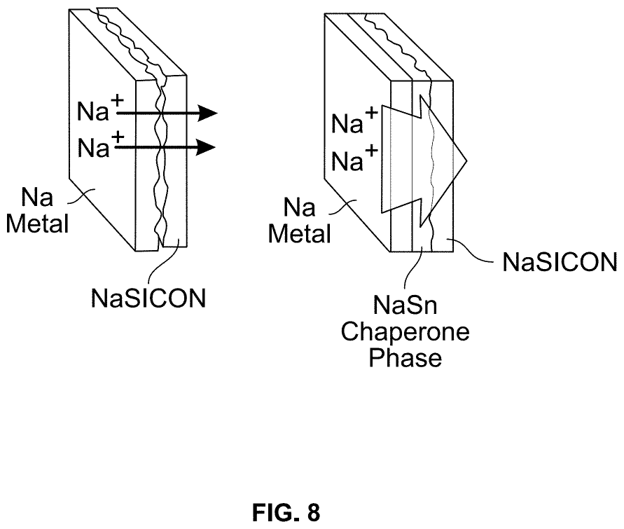

Air-sensitive XRD measurements were taken of the cycled Sn-coated NaSICON to characterize the NaSn chaperone phase. As shown in FIG. 7, XRD reveals the formation of the intermetallic phase NaSn. Identifying NaSn peaks are indicated by the orange diamonds. Based on this evidence, it was concluded that the excess Sn forms a sodium ion-conducting intermetallic phase, as shown in FIG. 8, rather than a blocking layer, on the surface of the NaSICON. No clear evidence of intermetallic formation was detected by XRD for static wetting tests, which may be due to the slow kinetics of sodiation when no bias is applied. See J. S. Gutierrez-Kolar et al., ACS Appl. Energy Mater. 2, 3578 (2018). This further indicates a dynamic formation of a NaSn intermetallic during symmetric cell cycling, rather than a spontaneous sodiation of the Sn simply by contact with the molten Na. The NaSn intermetallic is a specific crystalline ordering of the Sn and Na that facilitates Na+ movement along particular conduction pathways, as opposed to simple diffusion through a metal, as would be the case with a metal alloy. Interestingly, though both the 500 nm and 700 nm coating are above the critical thickness, an improvement in the 700 nm coating over the 500 nm coating was seen. While the 500 nm and 700 nm coatings both exhibited excellent wetting, there are still some regions where the NaSICON was not fully wet in the 500 nm coating symmetric cells. This incomplete wetting is likely related to the observed lower performance, possibly due to reduced Sn solubility on less optimally wetted surfaces.

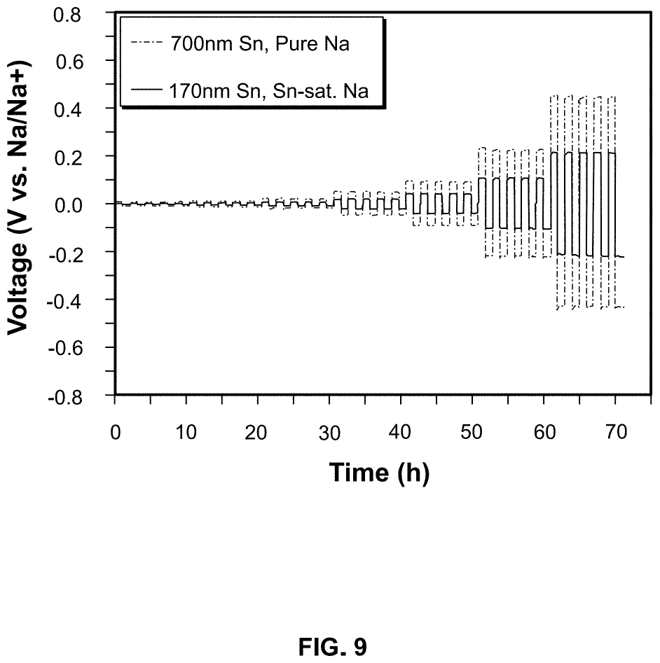

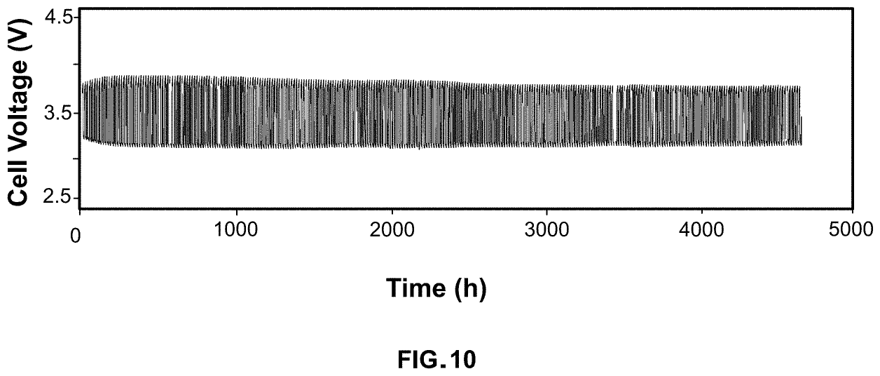

The best performance was achieved with a Na metal anode that was presaturated with Sn. FIG. 9 shows the measured voltages of an electrochemically cycled symmetric sodium cell assembled with 700-nm-thick Sn-coated NaSICON and a sodium cell assembled with 170-nm-thick Sn-coated NaSICON and the Na anode pre-saturated with Sn. The resulting thin NaSn chaperone phase minimizes the series resistance of the cell. FIG. 10 is a graph showing voltage cycling with a full cell having a Sn-coated NaSICON separator. Over 6.5 months of cycling was achieved with the full cell, thereby enabling long battery lifetime.

### Intermetallic Phases Formed from Other Metallic and Non-Metallic Precursor Coatings

As described above, a NaSn intermetallic phase can be formed due to sodium electrochemical reaction with a metallic coating, such as tin. Other metallic coatings that can form an intermetallic phase by electrochemical reaction with sodium include bismuth, lead, antimony, germanium, silicon, and gold. However, a precursor coating can be a non-metallic compound. This non-metallic precursor coating can first react chemically to form a metallic coating, followed by the electrochemical formation of an intermetallic phase. For example, the non-metallic precursor coating can be an oxide, sulfide, or other compound subject to chemical reaction and reduction to sodium metal. For example, in the case of the NaSn intermetallic, a tin oxide can be deposited. This tin oxide will react spontaneously with a small fraction of a metallic sodium anode:

2xNa+SnOₓ→xNa₂O+Sn

This chemical reaction, which can be predicted based on free energy calculations such as those evident in an Ellingham diagram, will create the metallic Sn needed for the subsequent electrochemical formation of the intermetallic NaSn phase. The chemical reaction may either be performed prior to introduction to the battery or the chemical reaction can be an in-situ reaction in an assembled battery prior to or concomitant with the electrochemical formation of the intermetallic phase.

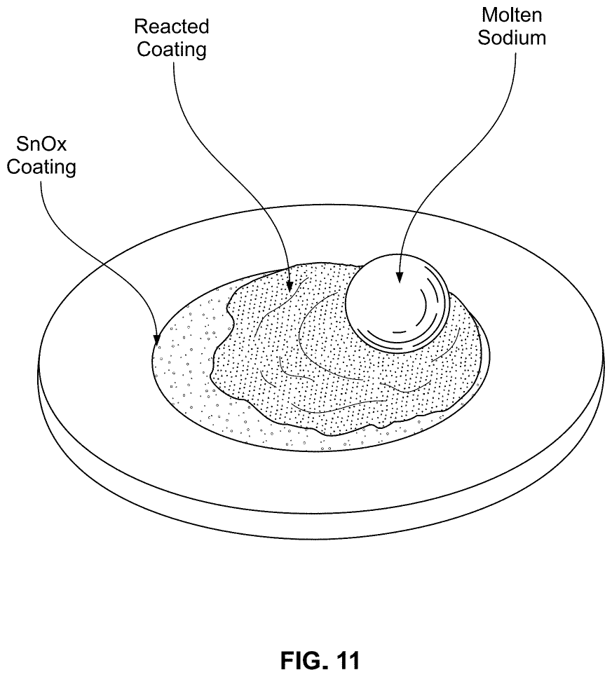

As an example, the precursor non-metallic coating can comprise a sol-gel deposited thin film of SnOₓ. In this case, a sol-gel precursor of Sn(IV)-acetate in water and methanol was spin-coated onto NaSICON and heated in air (>250° C.) to form the SnOₓ coating. This coating was exposed to molten sodium. The evident reaction of the metallic sodium with the SnOₓ to form Sn is shown in FIG. 11. The photograph indicates the underlying very light gray SnOₓ coating on the white NaSICON pellet and the formation of a dark gray Sn reacted coating advancing from the molten sodium droplet toward the edge of the SnOₓ.

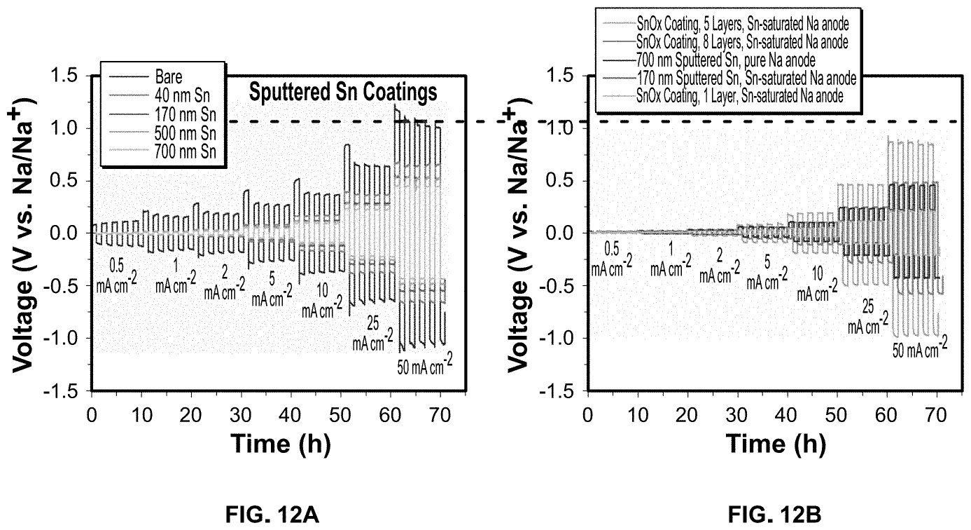

This SnOₓ coating was introduced on both sides of a NaSICON pellet and the pellet was introduced to a symmetric electrochemical cell shown in FIG. 2 with sodium on both sides of the cell. The cell was electrochemically cycled at varying current densities, and the resulting overpotentials are shown in FIG. 12B. FIGS. 12A (reproduced from FIG. 5A) and 12B compare the performance of an uncoated NaSICON pellet (as shown by the horizontal dashed line) and comparable Sn layers (FIG. 12A) to the SnOₓ films (FIG. 12B). The data in the FIG. 12A shows the beneficial influence on charge transfer efficiency of the metallic Sn coating. The data in FIG. 12B shows the SnOₓ-coated NaSICON reduced the cell overpotentials relative to the uncoated NaSICON cell, a trend consistent with that seen previously with pure Sn coatings. This reduction in cell overpotential on cell cycling is an indicator of improved cell performance in a functioning battery.

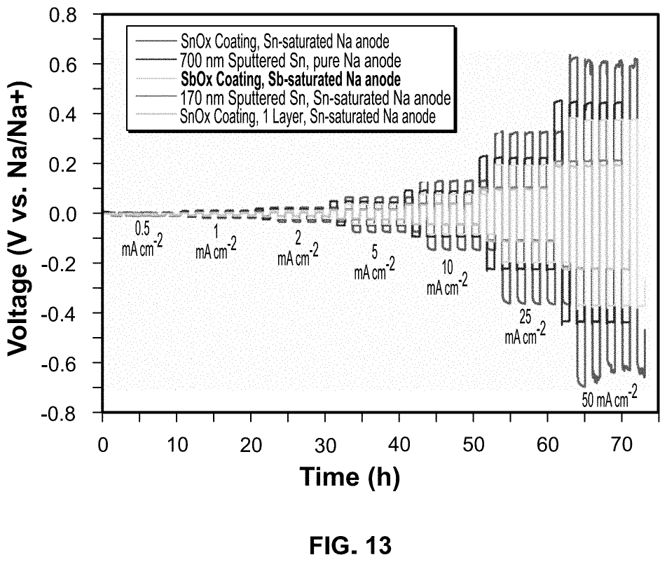

The method described above can be applied to other materials capable of forming sodium intermetallic phases. For example, an SbOₓ precursor coating can also be used to improve the electrochemical performance (reduced overpotentials in symmetric cell cycling). FIG. 13 compares the impact of SbOₓ, SnOₓ, and pure Sn. The SbOₓ coating, when subject to chemical reduction by molten sodium to metallic Sb, shows similar performance to pure Sn and SnOₓ coatings.

In general, the method (including metal or non-metal precursor) can be extended to include any materials capable of forming intermetallics with sodium. Commonly recognized types of intermetallic phases include:
Laves phases (type AB2, e.g. CaMg2)
Heusler phases (ABC, A2BC, e.g. Cu2MnAl)
Zintl phases (type AB, between alkaline and alkaline-earth
metals and electronegative elements of the 13th to 16th main group, e.g. NaSi)
Hum-Rothery phases, characterized by their fixed valency-electron concentration (α-, β-, ψ-, δ-brass).
   Examples of other intermetallic compounds of interest include, but are not limited to:
Bismuth intermetallics: (e.g., NaBi, Na₃Bi). See M. Wu et al., Chem. Eng. J. 381, 122558 (2020)
Lead intermetallics: (e.g., Na₁₅Pb₉, Na₅Pb₂, NaPb, NaPb₃). See T. R. Jow et al., J. Electrochem. Soc. 134(7), 1730 (1987)
Germanium intermetallics: (e.g., NaGe). See X. Lu et al., Chem. Mater. 28(4), 1236 (2016).
Silicon intermetallics: (e.g., NaSi)
Antimony and tin intermetallics and intermetallic alloys, including:
   Na—Sn (e.g., Na₁₅Sn₄, Na₃Sn, Na₄Sn₃, Na₉Sn₄, NaSn₃, NaSn₄, NaSn₆, α-NaSn, β-NaSn)
   Na—Sb (e.g., Na₃Sb, NaSb)
   Sn—Sb (e.g., Sn₃Sb₂, SnSb)
   Na—Sn—Sb (e.g., Na₅SnSb₃, Na₈SnSb₄)

See J. S. Gutiérrez-Kolar et al., ACS Appl. Energy Mater. 2(5), 3578 (2019).
Antimony-transition metal intermetallics (e.g., NaₓCoSb, NaₓSnSb, NaₓCu₂Sb, NaₓCu₁₁Sb₃, NaₓNiSb, NaₓZn₄Sb₃). See W. Luo et al., Rare Metals 36(5), 321 (2017)
Gold and gold-transition metal intermetallics (e.g., Au₅Na, Au₂Na, AuNa, AuNa₂). See A. D. Pelton, Bull. Alloy Phase Diagr. 7, 136 (1986)
Any of the intermetallics including Na and Au with Mg, Al, Zn, Cd, Pb, Cd, Tl, Ge, Sn, or Ga. See V. Smetana, et al., Angew. Chem. Int. Ed. 51(51), 12699 (2012)

Either the metallic or non-metallic precursor coating can be single materials (e.g., tin) or they may be part of a composite. This composite can include only components that are active in the process (for example, SbOₓ and SnOₓ) or they can include a mixture of materials that are active in the formation of the intermetallic phase and materials that are inactive with respect to the intermetallic formation. For example, the material may comprise SnOₓ and a polymer or carbon component intended to perform a secondary function.

In addition to pure sodium anodes or sodium saturated with the intermetallic-forming metal, the approach can be used with anodes comprising alloys of sodium, including NaK, NaCs, and NaRb, which may be applied for lower-temperature battery operations. In addition to sodium metal anodes, the approach is also applicable to other metal anodes including, but not limited to, lithium, potassium, zinc, calcium, magnesium, aluminum, or other metals capable of forming intermetallics.

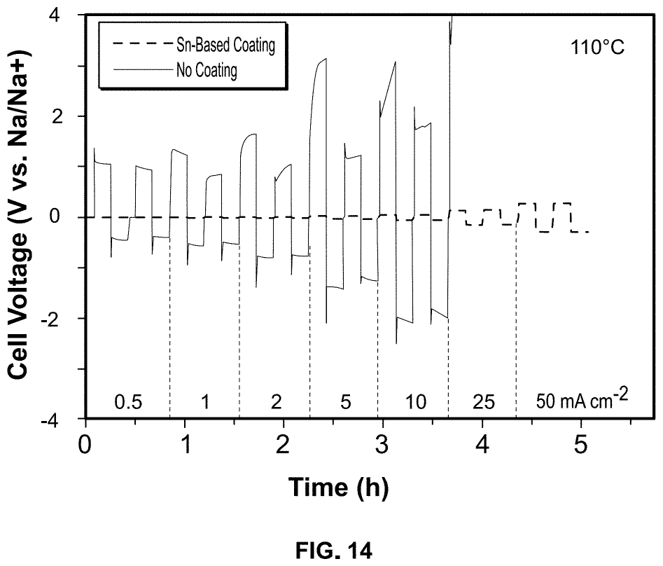

In addition to the exemplary NaSICON ceramics, the method can be applied to other sodium ion-conducting ceramics. A common example would include β″-alumina. FIG. 14 shows the impact of a sputtered Sn coating on a β″-alumina separator (sputtered on both sides in a symmetric molten sodium cell). The figure shows that the Sn-based coating also dramatically reduces overpotentials, compared to the uncoated separator.

The present invention has been described as a method to improve electrochemical interfaces of sodium ion-conducting ceramics for improved sodium electrochemical interfaces. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A method to improve a sodium electrochemical interface, comprising:
providing a sodium ion-conducting ceramic;
depositing a coating comprising tin, bismuth, lead, antimony, germanium, silicon, or gold on a surface of the sodium ion-conducting ceramic; and
forming a sodium ion-conducting sodium-tin, sodium-bismuth, sodium-lead, sodium-antimony, sodium-germanium, sodium-silicon, or sodium-gold intermetallic phase on the surface of the sodium ion-conducting type ceramic by sodium electrochemical reaction, thereby providing a sodium electrochemical interface with improved sodium ion conduction from a sodium source through the sodium ion-conducting ceramic.

2. The method of claim 1, wherein the sodium ion-conducting ceramic comprises NaSICON or β″-alumina.

3. The method of claim 1, wherein the sodium source comprises sodium metal or a sodium metal alloy.

4. The method of claim 1, wherein the step of depositing a coating comprises coating the surface of the sodium ion-conducting ceramic with metallic tin, bismuth, lead, antimony, germanium, silicon, gold or alloy thereof.

5. The method of claim 1, wherein the step of depositing a coating comprises coating the surface of the sodium ion-conducting ceramic with non-metallic compound comprising tin, bismuth, lead, antimony, germanium, silicon, gold and chemically reducing the non-metallic compound to a metal.

6. The method of claim 5, wherein the non-metallic compound comprises and oxide or sulfide.

7. The method of claim 6, wherein the oxide comprises SnOₓ, SbOₓ, or GeOₓ.

8. The method of claim 1, wherein the sodium-tin intermetallic phase comprises Na₁₅Sn₄, Na₃Sn, Na₄Sn₃, Na₉Sn₄, NaSn₃, NaSn₄, NaSn₆, α-NaSn, or β-NaSn.

9. The method of claim 1, wherein the sodium-bismuth intermetallic phase comprises NaBi or Na₃Bi).

10. The method of claim 1, wherein the sodium-lead intermetallic phase comprises Na₁₅Pb₉, Na₅Pb₂, NaPb, or NaPb₃.

11. The method of claim 1, wherein the sodium-germanium intermetallic phase comprises NaGe.

12. The method of claim 1, wherein the sodium-silicon intermetallic phase comprises NaSi.

13. The method of claim 1, wherein the sodium-antimony intermetallic phase comprises Na₃Sb or NaSb.

14. The method of claim 1, wherein the sodium-gold intermetallic phase comprises Au₅Na, Au₂Na, AuNa, AuNa₂.

15. The method of claim 1, wherein the intermetallic phase comprises an intermetallic alloy phase.

16. The method of claim 15, wherein the intermetallic alloy phase comprises Na₅SnSb₃ or Na₈SnSb₄.

17. The method of claim 15, wherein the intermetallic alloy phase comprises an antimony-transition metal intermetallic phase.

18. The method of claim 17, wherein the antimony-transition metal intermetallic phase comprises NaₓCoSb, NaₓSnSb, NaₓCu₂Sb, NaₓCu₁₁Sb₃, NaₓNiSb, or NaₓZn₄Sb₃.

19. The method of claim 15, wherein the intermetallic alloy phase comprises a gold-transition metal intermetallic phase.

20. The method of claim 19, wherein the gold-transition metal intermetallic alloy phase comprises Na, Au, and Mg, Al, Zn, Cd, Pb, Cd, Tl, Ge, Sn, or Ga.

21. A method to improve a sodium electrochemical interface, comprising:
providing a sodium ion-conducting ceramic;
modifying the material structure of a surface or bulk of the sodium ion-conducting ceramic to include tin, bismuth, lead, antimony, germanium, silicon, or gold; and
forming a sodium ion-conducting sodium-tin, sodium-bismuth, sodium-lead, sodium-antimony, sodium-germanium, sodium-silicon, or sodium-gold intermetallic phase on the surface of the sodium ion-conducting type ceramic by sodium electrochemical reaction, thereby providing a sodium electrochemical interface with improved sodium ion conduction from a sodium source through the sodium ion-conducting ceramic.
